(19) United States
(12) Patent Application Publication
(10) Pub. No.: US 2026/0061456 A1
(43) Pub. Date: Mar. 5, 2026

(54) Determining Optimized Operating Parameters for a Coating Process

(71) Applicant: Siemens Aktiengesellschaft, Muenchen (DE)

(72) Inventors: Theresa PASCH, München (DE); Vincent MALIK, München (DE); Hans MAUSER, München (DE); Jonas PILS, Erlangen (DE); Stephan KARL, Eichstätt (DE); Marco NEHMEIER, Uehlfeld (DE); Ralf DIEHM, Karlsruhe (DE); Christian WITTUM, Walzbachtal (DE); Patrick STÖRNER, Karlsruhe (DE)

(21) Appl. No.: 19/314,142

(22) Filed: Aug. 29, 2025

(30) Foreign Application Priority Data
Sep. 2, 2024 (EP) 24197951

(51) Int. Cl. B05D 1/00; B05D 5/12; G05B 13/04

(52) U.S. Cl. CPC B05D 1/00; B05D 5/12; G05B 13/041

(57) ABSTRACT

A computer-implemented method, a computer-implemented device, a system and a computer program product for determining optimized operating parameters for a coating process includes recording at least one process parameter associated with the coating process, determining a target parameter range associated with a coating that is produced by the coating process, the determination being based on an analytical model and/or a three-dimensional computational fluid dynamics (CFD) model, and determining an operating parameter for the coating process at least partially based on the recorded parameter and the target parameter range.

### BACKGROUND OF THE INVENTION

### 1. Field of the Invention

The present invention relates to a computer-implemented method, a computer-implemented device, a system and a computer program product for determining optimized operating parameters for a coating process.

### 2. Description of the Related Art

The energy revolution currently occurring, which comprises a departure from the combustion of fossil fuels in favour of the use of renewable and sustainable raw materials, in many respects requires the further development and/or redevelopment of energy-generating media and/or energy-storing media. This may comprise, for example, the further development of batteries (as energy storage media) and/or fuel cells as energy generation media.

In the production of batteries, anodes and/or cathodes are often coated in order to be able to introduce an active, i.e., energy-storing material (e.g., lithium metal oxides) into the respective battery. A similar observation may be made, for example, for bipolar plates of a fuel cell, which are also coated in order to be able to protect them from oxidation and/or corrosion.

In order to guarantee the desired functionality of a battery and/or fuel cell produced in this way, accurate process monitoring of the coating process is required in order to be able to ensure a deterministic and stable process sequence.

Until now, the problem of process monitoring and stability in coating installations has been solved primarily by manually monitoring and intervening in the coating process. The process parameters are regularly monitored by a user and/or technician of an industrial coating installation and corrected by manual corrections in the event of deviations. The basis for this is the experience and expertise of the users and technicians.

However, this is often time-consuming and may involve human error, as a result of which a malfunction that may arise during the coating process is discovered too late or is not discovered at all. Furthermore, only very experienced machine operators are usually able to understand the relationships between the various installation, process and material parameters to the required extent, to identify a malfunction and to take adequate countermeasures in order to appropriately counteract the malfunction.

Furthermore, due to the complexity of a coating process, process parameters associated therewith may often not be considered in isolation from each other, but often require analysis in their entirety, because the respective process parameters may be mutually interdependent. Interpreting such a dependency in particular requires experienced staff and may be considered complex and time-consuming.

This also means that a comparison of each process parameter with predetermined target values is usually not sufficient, because the relationships between all the parameters result in a stable or unstable coating.

Some coating installations have rudimentary control systems that allow automatic regulation of some process parameters. However, this regulation is often based on fixed threshold values and cannot cover the entire range of process optimization, as the functionality thereof is usually (greatly) limited.

The interval within which a process parameter can move in order to still be considered acceptable for the coating process is referred to as a process window, where the process window may be described by a target parameter range. These are usually only calculated in rare cases by trained process engineers during the process development and are alternatively often based on estimates or rough empirical values. There is not usually an automatic recalculation during production in the event of (environmental) conditions that have changed during the coating process.

Methods currently used for monitoring also do not use real-time data in all cases, with the result that a coating that may be considered insufficient is usually only able to be identified with a time delay and a non-optimal coating process initially continues, which can be accompanied by a reduced quality in the final product.

There is therefore a need to provide a further development of the monitoring of a coating process, where the aforementioned disadvantages are at least partially overcome.

### SUMMARY OF THE INVENTION

In view of the foregoing, it is an object of the present invention to provide a more efficient and improved method for controlling a coating process.

This and other objects and advantages are achieved in accordance with the invention by a computer-implemented method for determining optimized operating parameters for a coating process. The computer-implemented method may comprise recording at least one parameter associated with the coating process and determining a target parameter range associated with a coating that is produced by the coating process, where the determination is based on an analytical model and/or a three-dimensional computational fluid dynamics (CFD) model. Furthermore, the computer-implemented method may comprise determining an operating parameter for the coating process at least partially based on the recorded parameter and the target parameter range.

An optimized operating parameter may be understood to mean a parameter that may be used as an adjustment parameter of a device used for the coating process and is distinguished by the fact that the optimized operating parameter may be understood to be the operating parameter that results in at least one process parameter that should be considered to be ideal if the device used for the coating is operated using the optimized operating parameter or the optimal operating parameters.

Here, a target parameter range may be understood to mean a range within which a specific value of the process parameter may fluctuate or lie according to the application in order to be able to implemented a coating process in accordance with the instant disclosure.

A CFD model may be understood to mean a computer-aided method for calculating and analysing flows, heat transfer, coating processes, etc., and related phenomena that are based on the solution of fundamental physical or hydrodynamic conservation equations. It may comprise a discretization of a computational domain, where the volume to be examined may be divided into a plurality of small grid cells that may be adapted to the geometry and structure of the system to be analysed. The underlying model can solve nonlinear partial differential equations for mass, momentum, and energy conservation in each grid cell and may allow the calculation of relevant physical variables such as pressure, temperature, density, and flow velocity as a function of time and location. Here, specific boundary conditions, such as geometry, material properties and external influences, may be integrated into the calculations. The calculated data may be represented as three-dimensional fields in order to be able to comprehensively describe the dynamic development of the simulated system. This CFD model may allow a detailed and realistic simulation of complex flow processes and may be used to optimize designs, processes or systems in various technical areas of application.

In some cases, at least one further model for determining the target parameter range may be added, which may also take into account, for example, an error effect of a coating process that is not yet known.

The determination of the target parameter range may take into account a correlation of different operating parameters and/or process parameters (and a correlation relative to one another).

The monitoring by recording a process parameter and determining an operating parameter make it possible to allow continuous improvement of the coating process over time. Process monitoring and control in coating installations may therefore be improved by providing an advanced, automated solution for better production performance and quality. This may result in greater efficiency, lower discard rates and lower operating costs overall. This in turn may contribute to higher product quality, process stability, efficiency and cost efficiency of the coating process. In particular, the definition of a target parameter range may allow the definition of a stable working range, and therefore a stable sequence of the coating process may be made possible and, for example, undesired raised edges may be avoided. Furthermore, the determination of the target parameter range allows a better adaptation of the coating process to conditions that are actually present, since these are not solely based on (one-off) preliminary calculations.

In accordance with one embodiment, the recording may comprise recording a real-time process parameter, a static parameter that is associated with a coating installation that implements the coating process, and/or a material parameter used for the coating.

A real-time process parameter may be understood to mean a process parameter that is recorded during the running time of a coating process. The real-time process parameter may be recorded directly by sensors and is not taken from a database of process parameters recorded in advance. The real-time process data may recorded continuously (i.e. at a predetermined sampling rate of, for example, 0.5 Hz-10 Hz, 11 Hz-100 Hz, 101 Hz-1 kHz, 1 kHz-10 KHz or a higher sampling rate).

By way of example, the static parameter may be provided as a parameter that is associated with a device used for the coating process. A parameter associated with the device used for the coating process may, for example, be a parameter that may be associated with a nozzle geometry (for example, an opening width, a nozzle length, a nozzle shape, a parameter describing a cavity, position of the nozzle, gap distance, and/or the amount of material supplied to the nozzle) of the device, where the nozzle may be configured such that the coating material escapes from it during the coating process. Additionally or alternatively, the static parameter may also indicate a minimum gap distance. In some cases, the gap distance may also be non-static, and instead, for example, may be positioned dynamically, for example with the aid of a screw system (for example, via appropriately provided flexible lips). In some cases, the static parameter may also describe a shape and/or geometry of the nozzle lip.

A material parameter may be understood to mean, for example, a viscosity of the coating material used for the coating process. Additionally or alternatively, the material parameter may also indicate a surface tension, a density and/or a solids content of the material used for the coating. In some cases, these parameters can be recorded in real time (for example, by sensors contained in the device used for coating). Additionally or alternatively, it may also be possible for material samples of the material used to be tested in a laboratory. The relevant parameters may then be made available via a connection of a laboratory data management system and therefore finally recorded, or a laboratory employee may (manually) enter the respective material parameters in a separate input mask, with the result that the material parameters may ultimately be recorded as a result.

In some cases, the material may comprise, for example, for the coating of a battery anode, lithium (lithium metal or lithium compounds such as lithium titanate), graphite (graphite is often used as an anode material in lithium-ion batteries), and/or silicon (silicon may be used in some advanced batteries as an anode material because it provides a higher capacity than graphite).

In some cases, the material may comprise, for example, for the coating of a battery cathode, lithium iron phosphate (commonly used as a cathode material in lithium-ion batteries) and/or lithium nickel cobalt oxide, lithium manganese oxide, or lithium nickel manganese oxide (also used in lithium-ion batteries and provide a higher energy density than lithium iron phosphate).

In this way, there may be an efficient reaction to a currently prevailing actual parameter, for example, through provision of the operating parameter, and therefore a continuously improved coating process may be made possible overall. In particular, the use of real-time process parameters may allow continuous recording of a deviation of a process parameter from an ideal state in an immediate and timely manner, and therefore improved and immediate countermeasures are able to be taken, rather than having to rely on regular and/or irregular inspections.

In accordance with a further embodiment, the target parameter range may indicate a maximum tolerable thickness variation of the coating.

Here, a thickness variation may be understood to mean the standard deviation of the thickness of the coating over a part or substrate to be coated (e.g., along a longitudinal and/or width direction).

“Maximum tolerable” may be understood to mean the thickness variation that only just allows a required and/or desired function of the coating.

Limiting the target parameter range to a maximum tolerable thickness variation makes it possible to define a thickness distribution of the coating over the part to be coated in an efficient manner such that the coating may fully perform its target function (e.g., providing energy sources in a battery).

In accordance with a further embodiment, the analytical model may comprise a physical law describing the coating process and preferably describe at least one defect that may occur during the coating operation, preferably a formation of ripples in the coating, an air inclusion in the coating and/or a formation of streaks in the coating.

An analytical model may be understood to mean a physical equation that may describe the coating process at least partially based on natural laws. The physical equation may be given as a one-dimensional equation.

A formation of ripples in the coating may be understood to mean the at least local formation of curved elevations in the coating material. This may be caused, for example, by an excessively low coating thickness, an excessively large nozzle distance or an excessively high speed.

An air inclusion may be understood to mean the inclusion of air (bubbles) in the coating material. The air inclusion may already be present in the material that has not yet been applied to the substrate and/or may occur in an undesirable manner in the course of the coating process.

In the present case, a formation of streaks may be understood to mean the formation of density variations in the coating material that run in a strip-shaped manner.

This makes it possible for the analytical model to take into account the sources of error that occur most frequently and the effects thereof on the target parameter. This makes it possible to efficiently determine a range of values for the target process parameter within which a target parameter value can move without causing negative effects on the coating process as such.

In accordance with a further embodiment, the analytical model may include, as input parameters, at least one web speed, a coating gap, a wet film thickness, a lip length, a surface tension of a coating material, a density of the coating material and/or a viscosity of the coating material depending on a shear rate.

A shear rate may be understood to mean a measure that may be indicative of a rate of deformation of a fluid under the action of a shear force. The shear rate may indicate the change in velocity perpendicular to the flow direction. Mathematically, the shear rate may be expressed as the gradient of the flow velocity perpendicular to the main flow direction. In a CFD model, the shear rate may represent a variable for characterizing the flow behaviour of fluids, in particular in the case of non-Newtonian fluids whose viscosity is dependent on the shear rate. The shear rate may provide information about local flow conditions, turbulence and potential material loads in flow-related applications.

This may allow a more targeted adaptation of the target parameter range depending on actual installation and/or material parameters. A realistic target parameter range that is adapted to conditions that are actually present is therefore able to be efficiently provided.

In accordance with yet a further embodiment, the determination of the target parameter range may be based on a model derived from the three-dimensional CFD model and takes into account a thickness profile of the coating.

Based on the CFD model, three-dimensional coating defects in a coating may be taken into account. Incorporating a thickness profile in the CFD model makes it possible to adapt the CFD model to an actual coating in a more targeted and accurate manner, therefore allowing a more accurate representation of reality. This makes it possible to determine the target parameter range in an improved and more realistic manner.

In accordance with a further embodiment, the determination of the target parameter range may at least partially be based on a consideration of physical and/or process-engineering limits, preferably due to air entrainment, a minimum coating gap, a low flow limit and/or a maximum wet film thickness.

Physical limits may be understood to mean limits that, for example, are caused by material properties of the coating material, such as a maximum or minimum viscosity, a maximum or minimum density of the coating material (for example at different temperatures). Here, process-engineering limits may be understood to mean limits that may be caused by the coating process as such, such as limits that are caused, for example, by limitations of the device used for the coating (for example, due to a maximum material throughput, maximum and/or minimum process temperatures, and/or minimum nozzle distance).

In the present case, “air entrainment” may be understood to mean values in the target parameter range at which and/or from which an instability of the dynamic contact line that occurs between the coating material and the substrate on which the coating material is applied may result in air entering the coating film.

Holes in the coating layer, which occur regularly over the entire coating width, and longitudinal strips in the coating layer may be understood to be characteristic of “air entrainment”. The effect of “air entrainment” may occur, for example, in the event of an excessively low wet film thickness, an excessively large nozzle distance, an excessively high speed (for example, if a speed at which the substrate is moved is more than 100 m/min, where a typical speed range may be between 40 m/min and 100 m/min) and/or disadvantageous properties of the coating material.

The “minimum coating gap” may be understood to mean the minimum distance between a slit nozzle and a coating roller (a device used for the coating), which, for safe operation of the coating installation, must not be fallen below. This may be fixedly predetermined by the installation consisting of a slit nozzle, a positioning system and a coating roller.

The “low flow limit” may be understood to mean the instability of a film-forming meniscus. If the film-forming meniscus is too greatly curved, then it can no longer form a stable bridge between the lip and the coating. The film-forming meniscus may be understood to mean a concave or convex curvature, which is formed at the boundary between the nozzle and the coating material in the coating direction. The exact configuration of the film-forming meniscus may be dependent on various factors, such as the viscosity of the fluid, the surface tension, the nozzle design and the process parameters, for example. It may be of particular importance to monitor and control the meniscus during the coating process to ensure uniform and precise coating.

Possible wet film thicknesses may have an upper limit due to a gap distance (for example, between an outlet nozzle of the device used for the coating and the substrate on which the coating is to be applied). Higher wet film thicknesses may cause the coating compound to run out of the coating gap in the opposite direction to the coating direction. Characteristically, when the limit is exceeded, very high raised edges and variations in the coating width occur.

Characteristic of the “low flow limit” may be understood to mean, for example, longitudinal strips that are distributed regularly over the entire coating width.

By way of example, influencing factors relevant to the “low flow limit” may include an excessively low wet film thickness, an excessively large nozzle distance (describing the distance between a nozzle outlet and the substrate that is to be coated), an excessively high speed (i.e., a speed at which the substrate is moved) and/or properties of the coating material.

This may allow further targeted adaptation of the target parameter range to actual conditions and therefore further optimize and improve the coating process as such.

In accordance with an even further embodiment, the computer-implemented method may further comprise recording an operating parameter, which is currently in use, for the coating process and comparing the operating parameter that is currently in use with the determined operating parameter. Furthermore, the computer-implemented method may comprise determining, at least partially based on the comparison, that the operating parameter that is currently in use does not correspond to the determined operating parameter.

By way of example, an operating parameter that is currently in use may be an operating parameter that is recorded continuously or at (predefined) preferably fixed time intervals. The operating parameter that is currently in use may be read directly from a device used for the coating process. Additionally or alternatively, the operating parameter that is currently in use may be read from a database (which may be accessed via an intranet and/or the Internet, for example).

Determining that the operating parameter that is currently in use does not correspond to the determined operating parameter may, for example, means that the operating parameter that is currently in use is smaller or larger than the determined operating parameter. Alternatively, the determination may also comprise determining that an operating parameter that is currently in use does not correspond to the determined operating parameter in terms of its Boolean value.

This may allow an efficient determination as to whether there is a current deviation of a determined operating parameter (and therefore an operating parameter that may be considered to be optimized) from an operating parameter that is currently in use.

In accordance with a further embodiment, the computer-implemented method may comprise providing a notification that is indicative of the fact that the operating parameter that is currently in use is not an optimized operating parameter and/or providing a recommendation that the determined operating parameter results in a process parameter that is improved in comparison to the operating parameter that is currently in use and/or adjusting the coating installation to the determined operating parameter.

The notification may be provided to a user of the device used for the coating via a human-computer interface (human-machine interface (HMI)). The human-computer interface may be, for example, a display means (such as a display, an app, and/or a push notification), an acoustic output means (for example, a loudspeaker (where the notification may be provided as an alarm and/or spoken content)) and/or a visual display means (for example, a warning lamp).

The recommendation may be provided via the human-computer interface. Based on the recommendation, the user of the device used for the coating may confirm that the determined operating parameter should be used and that the device used for the coating should be adjusted to the determined operating parameter. In some cases, the user of the device used for the coating may also reject the recommendation, with the result that the device used for the coating is accordingly not adjusted to the determined operating parameter.

In this way, an immediate notification of a user of the device used for the coating can be made possible. This may support rapid intervention in the coating process, with the result that the time period during which the coating process is running at an operating point that is not considered optimal is minimized. Therefore, the coating quality resulting from the coating process may be improved. In particular, immediate adjustment may reduce the need for human intervention and therefore enable automatic adaptation to ensure the stability and quality of the coating process.

In accordance with a still further embodiment, the coating may be used to coat an anode and/or a cathode of a battery.

Additionally or alternatively, the coating may also be used in the production of fuel cells, such as in the coating of electrodes, membranes and/or bipolar plates, for example. In some cases, the coating may also be used to coat other parts. This may support an optimized and improved production of batteries and/or fuel cells.

In accordance with a further embodiment, a thickness of the coating may be 150-200 μm and a fluctuation of the thickness over a width of the coating may be less than 2 μm. In some cases, a width of the coating may be 100 mm-2000 mm. Optimized functionality of the coating (for example, for applications in the production of batteries) may therefore be ensured.

The objects and advantages are also achieved in accordance with the invention by a computer program product comprising instructions which, when executed by a computer, cause the computer to execute the method in accordance with the disclosed embodiments.

A computer program product, such as a computer program means, for example, may be provided or delivered, for example, as a storage medium such as a memory card, a USB stick, a CD-ROM, a DVD, for example, or else in the form of a file downloadable from a server in a network. This may take place, for example, in a wireless communication network by way of transmitting an appropriate file comprising the computer program product or the computer program means. In some cases, the computer program product may also be understood to mean an application in the sense of an app (for example, for executing on a mobile device (for example, a tablet, and/or a mobile phone)).

The objects and advantages are further achieved in accordance with the invention by a computer-implemented device for determining optimized operating parameters for a coating process. The computer-implemented device may comprise a recording unit for recording at least one parameter associated with the coating process and a first determination unit for determining a target parameter range associated with a coating that has been produced by the coating process, where the determination is based on an analytical model and/or a three-dimensional computational fluid dynamics (CFD) model. Furthermore, the computer-implemented device may comprise a second determination unit for determining an operating parameter for the coating process at least partially based on the recorded parameter and the target parameter range.

The respective unit, for example the recording unit, the first determination unit and/or the second determination unit, may be implemented in the form of hardware and/or also in the form of software. In the case of an implementation in the form of hardware, the respective unit may be in the form of a device or part of a device, for example in the form of a computer or a microprocessor or a control computer of a vehicle. In the case of an implementation in the form of software, the respective unit may be in the form of a computer program product, a function, a routine, part of a program code or an executable object.

In accordance with one embodiment, the computer-implemented device may comprise an execution unit for executing the computer-implemented method in accordance with disclose embodiments and/or an execution unit for executing the computer program product in accordance with disclosed embodiments.

The objects and advantages are additionally achieved in accordance with the invention by a system for determining optimized operating parameters for a coating process. The system may comprise the computer-implemented device and the computer program product in accordance with disclosed embodiments as described herein.

In addition to automated real-time process monitoring and optimization, aspects of the invention may also be used in the process and material design phase before the actual coating process begins. In the planning phase of the device used for the coating process and the coating process itself, a process engineer may already define the process, device and material parameters based on the calculations of the target parameter range such that they are optimized for a stable coating. If the parameters are already defined in advance in a particular relationship to one another, it is possible for this, for example, the stable coating window, expressed by the target parameter range, to be increased and simplified, and therefore for the subsequent optimization of the process to be improved. Aspects of the invention may also allow the modelling of a digital process twin, which allows the coating process to be simulated even without a real device and to identify optimal parameters. This may result in shorter start-up phases during later operation.

The embodiments and features described for the proposed device apply accordingly to the proposed method. Conversely, the embodiments proposed for the method apply accordingly to the proposed device.

It should also be noted that even though different embodiments are described in isolation herein, they may still be combined with one another.

Further possible implementations of the invention also comprise not explicitly mentioned combinations of features or embodiments that have been described above or are described below with regard to the exemplary embodiments. In this case, a person skilled in the art will also add individual aspects as improvements or additions to the respective basic form of the invention.

### BRIEF DESCRIPTION OF THE DRAWINGS

The invention is explained in more detail below on the basis of preferred embodiments with reference to the attached figures, in which:

FIG. 1 shows an exemplary implementation of an inventive method for determining optimized operating parameters for a coating process;

FIG. 2 shows an exemplary cross section through a device used for a coating process;

FIG. 3 shows a flowchart of the computer-implemented method for determining optimized operating parameters for a coating process;

FIG. 4 shows an inventive computer-implemented device; and

FIG. 5 shows an inventive system.

### DETAILED DESCRIPTION OF THE EXEMPLARY EMBODIMENTS

In the figures, identical or functionally identical elements have been provided with the same reference signs, unless indicated otherwise.

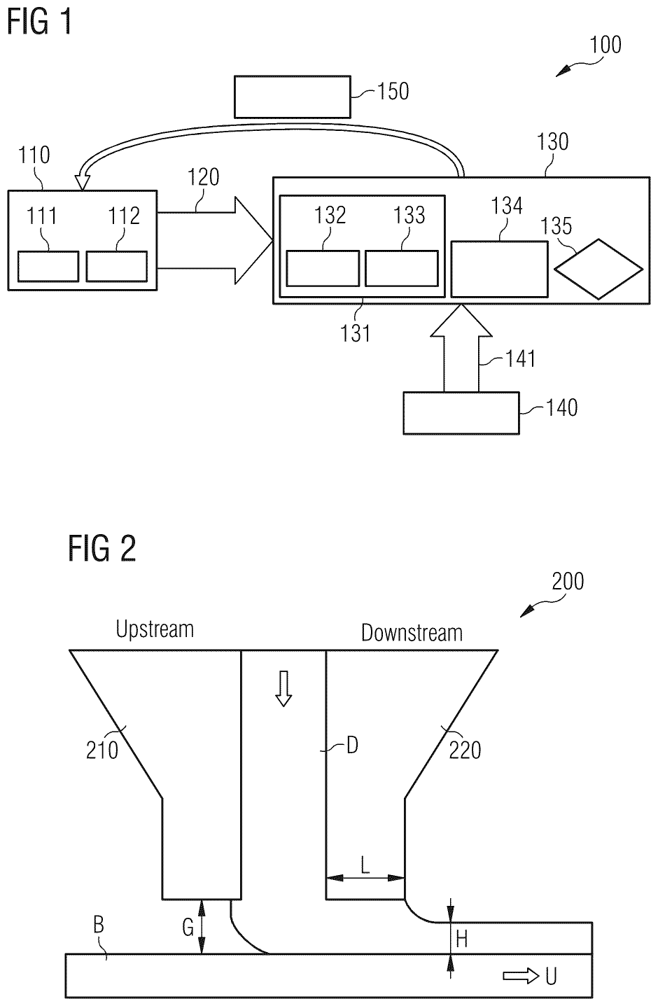

FIG. 1 shows an exemplary implementation of a method 100 for determining optimized operating parameters for a coating process.

A device 110 (herein also installation) used for the coating may comprise a controller 111 and a human-computer interface 112. The controller 111 may be configured to accept a determined operating parameter and, on the basis thereof, to cause the device 110 used for the coating to carry out a coating process based on the determined operating parameter.

The controller 111 may also be configured to record an operating parameter that is currently in use (for example, at least partially based on a corresponding sensor system as part of the device used for the coating process). In some cases, the controller 111 may also be configured to record a process parameter.

The human-computer interface 112 may be provided as described herein.

The installation 110 may be provided with a communication means. The communication means may make it possible to provide an installation or process parameter 120 to an optimization application 130. By way of example, the installation or process parameter 120 may comprise the operating parameter that is currently in use and/or an installation parameter and/or a process parameter (such as a measured current thickness of a coating layer, for example). An installation parameter may be an adjustment parameter of the device used for the coating and/or a parameter that with a component, which is relevant to the coating process, of the device used for the coating (such as a diameter of an outlet nozzle opening from which the coating material used for the coating is able to escape, for example).

The optimization application 130 may comprise a first determination unit 131 that is configured to determine a target parameter range for the coating applied on a substrate by the coating process. The first determination unit 131 may comprise an analytical model 132 and/or a CFD model 133.

The optimization application 130 may furthermore comprise a unit 134 for determining an operating parameter that is currently in use (for example, at least partially based on the installation and process parameter 120).

The optimization application 130 may furthermore comprise information 140 regarding the material used for the coating. The information 140 may be provided as a parameter 141 to the optimization application 130.

The optimization application 130 may be configured to determine an operating parameter, which may be considered to be an optimized operating parameter, based on the installation and process parameter 120, the parameter 141 and/or the operating parameter that is currently in use.

The optimization application 130 may furthermore comprise a checking unit 135. The checking unit 135 may be configured to check whether the determined operating parameter is the same as the operating parameter that is currently in use.

The optimization application 130 may be provided in the form of an app. In some, the optimization application may be executed on the device 110 used. Alternatively, the optimization application 130 may also be executed on a device that is separate from the device 110 used (for example, on the user's tablet).

The optimization application 130 may use “edge computing”. This may mean that the relevant data can be processed directly on the device used for the coating. This may significantly reduce latency and enable a rapid response to process changes. This may offer a clear speed advantage in comparison to central systems for which data has to be transferred.

The use of edge computers in conjunction with open interfaces such as OPC Unified Architecture (OPC-UA) may allow the system to be flexibly integrated into devices, which are used for coating processes, from different manufacturers with different device controllers. A complex and potentially error-prone intervention in the control of such a device is not necessary.

If, for example, it is determined that the determined operating parameter does not correspond to the operating parameter that is currently in use, on the basis thereof, the determined operating parameter may then be communicated as the optimized operating parameter 150 to the device 110 used, where the device 110 may adjust the corresponding operating parameter to the determined operating parameter on the basis thereof.

It should also be noted that even though one operating parameter is discussed herein, a plurality of operating parameters are equally possible.

FIG. 2 shows a schematic cross section 200 through a device used for a coating process. The cross section 200 divides the device used into an upstream section 210 and a downstream section 220. Here, the upstream section 210 is facing an inlet of the device used (i.e., that side of the device used on which a substrate, which is to undergo coating, is supplied to the device used). Here, the downstream section 220 may be characteristically understood to mean that side of the device used on which a coated substrate leaves the device used.

There may be an outlet opening of a nozzle D between the upstream section 210 and the downstream section.

By way of example, a wet film thickness H that indicates an average thickness of the coating layer applied to the substrate may be considered to be characteristic of the coating process.

Furthermore, a web speed U used may be relevant to the coating process. Here, the web speed U used may be associated with the speed at which a substrate to be coated is moved along on a belt B below the nozzle D.

Furthermore, a coating gap G may be relevant to the coating process. The coating gap may be understood to mean a distance between a belt B transporting the substrate and an underside of the nozzle D.

It is also possible for a lip length L to be relevant for the coating process. The lip length L may be understood to mean the distance between an inner wall of the nozzle D and an outer wall of the nozzle D along the downstream section 220. Here, the lip length L may indicate the length along which a coating material applied to the substrate may still be in contact with an underside of the nozzle D.

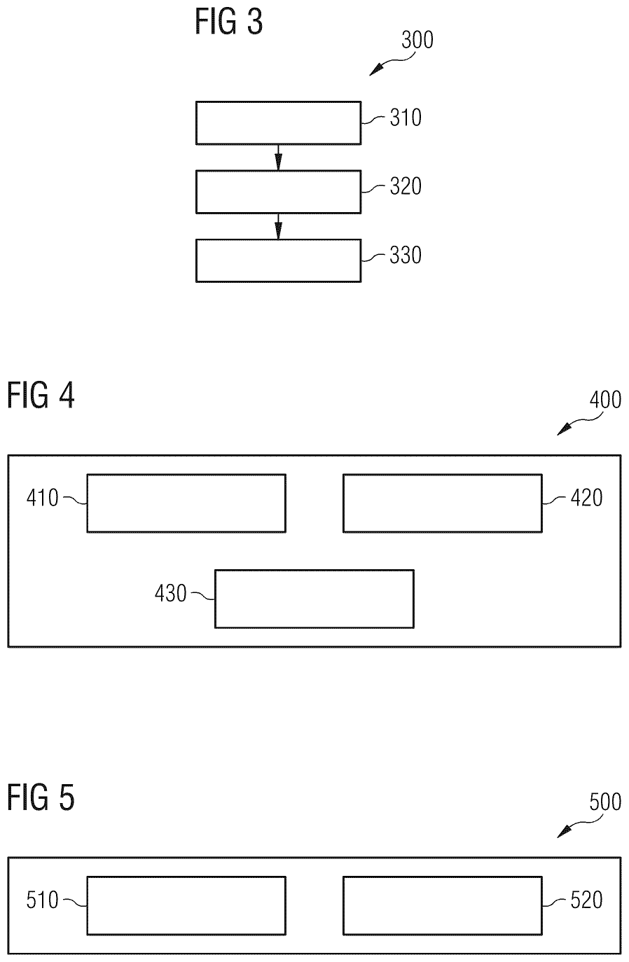

FIG. 3 shows a flowchart of an exemplary computer-implemented method 300 for determining optimized operating parameters for a coating process.

In step 310, at least one process parameter associated with the coating process is recorded.

In step 320, a target parameter range associated with a coating that is produced by the coating process is determined, where the determination is based on an analytical model and/or a three-dimensional computational fluid dynamics (CFD) model.

In step 330, an operating parameter for the coating process is determined at least partially based on the recorded parameter and the target parameter range.

FIG. 4 shows an exemplary computer-implemented device 400 for determining optimized operating parameters for a coating process. The computer-implemented device 400 comprises a recording unit 410, a first determination unit 420 and a second determination unit 430.

The recording unit 410 is configured to record at least one parameter associated with the coating process.

The first determination unit 420 is configured to determine a target parameter range associated with a coating that has been produced by the coating process, where the determination is based on an analytical model and/or a three-dimensional computational fluid dynamics (CFD) model.

The second determination unit 430 is configured to determine an operating parameter for the coating process at least partially based on the recorded parameter and the target parameter range.

FIG. 5 shows an exemplary system 500 for determining optimized operating parameters for a coating process. The system 500 includes a computer-implemented device 510 and a computer program product 520.

The computer-implemented device 510 may be configured as described herein.

The computer program product 520 may be configured as described herein.

Although the present invention has been described on the basis of exemplary embodiments, it is able to be modified in diverse ways. Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method for determining optimized operating parameters for a coating process, the method comprising:
recording at least one process parameter associated with the coating process;
determining a target parameter range associated with a coating which is produced by the coating process, the determination being based on at least one of an analytical model and a three-dimensional computational fluid dynamics (CFD) model; and
determining an operating parameter for the coating process at least partially based on the recorded parameter and the target parameter range.

2. The computer-implemented method as claimed in claim 1, wherein the recording comprises recording at least one of (i) a real-time process parameter, (ii) a static parameter which is associated with at least one of a coating installation which implements the coating process and (iii) a material parameter utilized for the coating.

3. The computer-implemented method as claimed in claim 1, wherein the target parameter range indicates a maximum tolerable thickness variation of the coating.

4. The computer-implemented method as claimed in claim 2, wherein the target parameter range indicates a maximum tolerable thickness variation of the coating.

5. The computer-implemented method as claimed in claim 1, wherein the analytical model comprises a physical law describing the coating process and describes at least one defect that may occur during the coating operation comprising at least one of (i) a formation of ripples in the coating, (ii) an air inclusion in the coating and (iii) a formation of streaks in the coating.

6. The computer-implemented method as claimed in claim 1, wherein the analytical model includes, as input parameters, at least one of (i) at least one web speed, (ii) a coating gap, (iii) a wet film thickness, (iv) a lip length, (v) a surface tension of a coating material, (vi) a density of the coating material and (vii) a viscosity of the coating material depending on a shear rate.

7. The computer-implemented method as claimed in claim 1, wherein the determination of the target parameter range is based on a model derived from the three-dimensional CFD model and takes into account a thickness profile of the coating.

8. The computer-implemented method as claimed in claim 1, wherein the determination of the target parameter range is at least partially based on a consideration of at least one of physical and process-engineering limits due to at least one of (i) air entrainment, (ii) a minimum coating gap, (iii) a low flow limit and (iv) a maximum wet film thickness.

9. The computer-implemented method as claimed in claim 1, further comprising:
recording an operating parameter, which is currently in use, for the coating process;
comparing the operating parameter which is currently in use with the determined operating parameter; and
determining, at least partially based on the comparison, that the operating parameter that is currently in use does not correspond to the determined operating parameter.

10. The computer-implemented method as claimed in claim 9, further comprising at least one of:
providing a notification that is indicative of the fact that the operating parameter which is currently in use is not an optimized operating parameter;
providing a recommendation that the determined operating parameter results in a process parameter which is improved in comparison to the operating parameter that is currently in use; and
adjusting the coating installation to the determined operating parameter.

11. The computer-implemented method as claimed in claim 1, wherein the coating is utilized to coat at least one of an anode and a cathode of a battery.

12. The computer-implemented method as claimed in claim 1, wherein a thickness of the coating is 150-200 μm and a fluctuation of the thickness over a width of the coating is less than 2 μm.

13. A computer program product stored in memory, the computer program product comprising instructions which, when executed by a computer, cause the computer to execute the method as claimed in claim 1.

14. A computer-implemented device for determining optimized operating parameters for a coating process, comprising:
a recording unit for recording at least one parameter associated with the coating process;
a first determination unit for determining a target parameter range associated with a coating that has been produced by the coating process, the determination being based on at least one of an analytical model and a three-dimensional computational fluid dynamics (CFD) model; and
a second determination unit for determining an operating parameter for the coating process at least partially based on the recorded parameter and the target parameter range.

15. The computer-implemented device as claimed in claim 14, further comprising:
an execution unit for executing a computer-implemented method or for executing a computer program product.

16. A system for determining optimized operating parameters for a coating process, comprising:
a computer-implemented device for determining optimized operating parameters for a coating process, a computer-implemented device including:
a recording unit for recording at least one parameter associated with the coating process;
a first determination unit for determining a target parameter range associated with a coating that has been produced by the coating process, the determination being based on at least one of an analytical model and a three-dimensional computational fluid dynamics (CFD) model; and
a second determination unit for determining an operating parameter for the coating process at least partially based on the recorded parameter and the target parameter range; and
a computer program product stored in memory, the computer program product comprising instructions which, when executed by a computer, cause the computer to execute a computer-implemented method for determining optimized operating parameters for the coating process.
